(19) United States
(12) Patent Application Publication
(10) Pub. No.: US 2007/0222320 A1
(43) Pub. Date: Sep. 27, 2007

(54) Molded rotor assembly for electric motors

(76) Inventor: Keith Kowalski, Bethlehem, CT (US)

Correspondence Address: JOHN H CROZIER, 1934 HUNTINGTON TURNPIKE, TRUMBULL, CT, 06611, US

(21) Appl. No.: 11/597,772

(22) PCT Filed: May 25, 2005
(86) PCT No.: PCT/US05/18383

§ 371 Date: Nov. 27, 2006

Related U.S. Application Data
(60) Provisional application No. 60/574,505, filed on May 26, 2004.

(51) Int. Cl. H02K 1/04; H02K 37/14

(52) U.S. Cl. 310/156.65; 310/49 R; 310/43

(57) ABSTRACT

In a preferred embodiment, an apparatus, including: first and second lamination stacks; a permanent magnet disposed between the lamination stacks; and the first and second lamination stacks and the permanent magnet being coated in one step with a plastic material.

### TECHNICAL FIELD

The present invention relates to rotors generally and, more particularly, to a novel molded rotor assembly for electric motors.

### BACKGROUND ART

Linear actuating stepping motors, for example, are often created by using a hollow threaded shaft in a traditional rotary motor. A number of materials may be used for the shaft nut; however, plastic is often desirable as it provides greater service life with minimal lubrication compared to metals.

In some motor designs, specifically the permanent magnetic or can stack designs, the tolerances are sufficient such that the entire shaft may be constructed of plastic and still allow the rotor to operate.

In a traditional permanent magnet rotor construction the magnet may be insert molded or bonded.

The hybrid stepping motor typically is constructed with tighter clearances between the rotating assembly (rotor) and the stator. The construction is also slightly different. The thread insert may be made of all metal (less desirable) or a composite assembly where the bearing journals are part of a metallic shell and the nut threads are composed of a molded-in or a separate plastic component. This type of assembly is also typically constructed by assembling the various components and grinding the outside diameter concentric to the bearing journals. However, the outside diameter is toothed and, consequently, the grinding operation will often cause burrs in the spaces between the teeth. So it is often necessary to remove these burrs. An alternative method is to coat the rotor with a non-metallic material such as an epoxy.

The various components of conventionally constructed motors are often assembled with adhesives, press fit to the shaft, or a combination of methods is used.

Accordingly, it is a principal object of the present invention to provide a molded rotor assembly for electric motors that is lower cost for price sensitive applications.

It is a further object of the invention to provide such a molded rotor assembly that uses the performance advantages of plastic threads often used for these applications; however, it is understood that there will be some sacrifices in performance due to increased clearances.

It is an additional object of the invention to provide such a system and that is easily and economically implemented.

Other objects of the present invention, as well as particular features, elements, and advantages thereof, will be elucidated in, or be apparent from, the following description and the accompanying drawing figure.

### DISCLOSURE OF INVENTION

The present invention achieves the above objects, among others, by providing, in preferred embodiment, an apparatus, comprising: first and second lamination stacks; a permanent magnet disposed between said lamination stacks; and said first and second lamination stacks and said permanent magnet being coated in one step with a plastic material.

### BRIEF DESCRIPTION OF DRAWINGS

Understanding of the present invention and the various aspects thereof will be facilitated by reference to the accompanying drawing figures, submitted for purposes of illustration only and not intended to define the scope of the invention, on which:

FIG. 1 is an isometric view of one type of conventionally constructed rotor assembly.

FIGS. 2A and 2B are side elevational and isometric views, respectively, of another type of conventionally constructed rotor assembly.

FIG. 3 is an end elevational view of a conventional rotor assembly after being ground.

FIG. 4 is a side elevational view of a rotor assembly constructed according to the present invention.

### BEST MODE FOR CARRYING OUT THE INVENTION

Reference should now be made to the drawing figures on which similar or identical elements are given consistent identifying numerals throughout the various figures thereof, and on which parenthetical references to figure numbers, when used, direct the reader to the view(s) on which the element(s) being described is (are) best seen, although the element(s) may be seen on other figures also.

FIG. 1 illustrates a traditional permanent magnet rotor construction, generally indicated by the reference numeral 10. Rotor construction 10 includes a smooth cylindrical member 20 which is a permanent magnet with multipole magnetization. A plastic insert 30 has internal threads 32 thereon and has bearing journals 34 and 36 at either end thereof. Here, the magnet may be insert-molded or bonded.

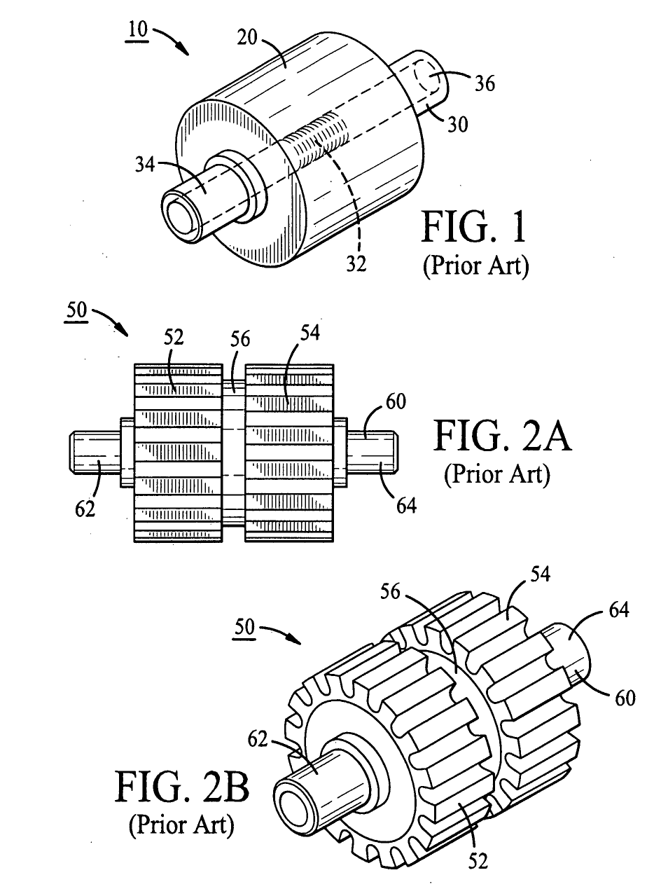

FIGS. 2A and 2B illustrate another type of rotor assembly, here, a rotor assembly for a hybrid stepping motor, generally indicated by the reference numeral 50, having first and second lamination stacks 52 and 54 surrounding a permanent magnet 56. This type of motor typically is constructed with tighter clearances between the rotating assembly (rotor) and the stator. The construction is also slightly different. The thread insert 60 may be made of all metal (less desirable) or a composite assembly where bearing journals 62 and 64 are part of a metallic shell and the nut threads are composed of a molded-in or separate plastic component. This type of assembly is also typically constructed by assembling the various components and grinding the outside diameter concentric to the bearing journals. As shown on FIGS. 2A and 2B, the outside diameter is toothed. Consequently, the grinding operation will often cause burrs in the spaces between the teeth. So it is often necessary to remove these burrs. An alternative method is to coat first and second rotor lamination stacks 52 and 54 with a non-metallic material such as an epoxy.

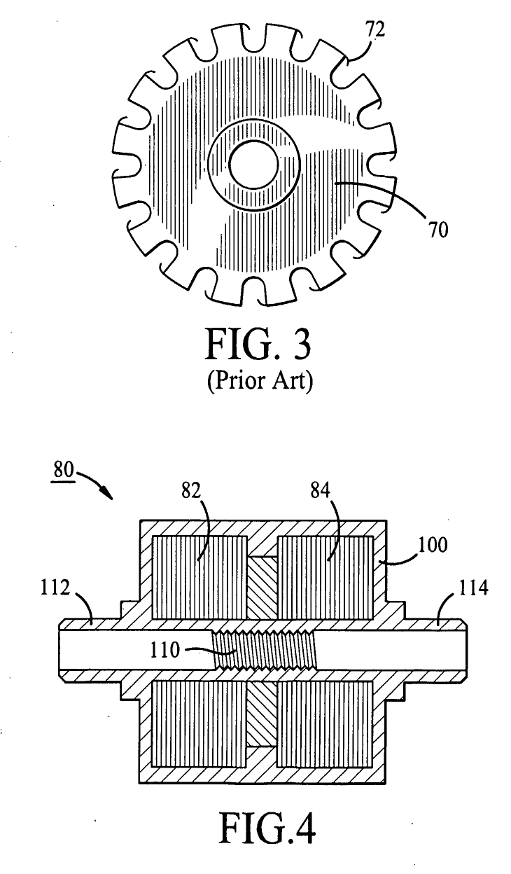

FIG. 3 illustrates a rotor 70 with burrs, as at 72, formed by the grinding operation, where the rotor lamination stacks of the rotor have not been coated.

The various components of conventionally constructed motors are often assembled with adhesives, press fit to the shaft, or a combination of methods is used.

FIG. 4 illustrates a rotor constructed according to the present invention, generally indicated by the reference numeral 80, having first and second lamination stacks 82 and 84. Here, the first and second lamination stacks 82 and 84 and magnet 90 are completely encapsulated as one molded assembly 100. Molded assembly 100 also forms internal threads 110, with an unscrewing mold, and bearing journals 112 and 114. After the molding process, the teeth of first and second lamination stacks 82 and 84 are ground to the finished dimension, leaving the plastic in the voids between the teeth to prevent burrs.

The prior art assemblies included several processes as follows:
1) machining of cylindrical shell/shaft,
2) molding of threads in shell/shaft,
3) assembly of shaft, magnet, rotor, laminations,
4) coating of rotor (if desired to eliminate burrs), and
5) grinding of rotor.

The design of the present invention reduces the steps to two as follows:
1) molding of plastic around laminations and magnet, and
2) grinding of rotor.

In the embodiments of the present invention described above, it will be recognized that individual elements and/or features thereof are not necessarily limited to a particular embodiment but, where applicable, are interchangeable and can be used in any selected embodiment even though such may not be specifically shown.

Spatially orienting terms such as “above”, “below”, “upper”, “lower”, “inner”, “outer”, “inwardly”, “outwardly”, “vertical”, “horizontal”, and the like, when used herein, refer to the positions of the respective elements shown on the accompanying drawing figures and the present invention is not necessarily limited to such positions.

It will thus be seen that the objects set forth above, among those elucidated in, or made apparent from, the preceding description, are efficiently attained and, since certain changes may be made in the above construction without departing from the scope of the invention, it is intended that all matter contained in the above description or shown on the accompanying drawing figures shall be interpreted as illustrative only and not in a limiting sense.

It is also to be understood that the following claims are intended to cover all of the generic and specific features of the invention herein described and all statements of the scope of the invention which, as a matter of language, might be said to fall therebetween.

The embodiments of the invention in which an exclusive property or privilege is claimed are defined as follows:

1. An apparatus, comprising:
(a) first and second lamination stacks;
(b) a permanent magnet disposed between said lamination stacks; and
(c) said first and second lamination stacks and said permanent magnet being coated in one step with a plastic material.

2. An apparatus, as defined in claim 1, wherein: said one step includes forming threads internally of said first and second lamination stacks, said threads being coaxial with said first and second lamination stacks and said magnet.

3. An apparatus, as defined in claim 1, wherein: said one step includes forming first and second bearing journals, said first and second bearing journals being coaxial with said first and second lamination stacks and said magnet.

4. An apparatus, as defined in claim 1, wherein: said plastic material is left in teeth formed in said first and second lamination stacks to prevent formation of burrs when said first and second lamination stacks are subsequently ground.
